(19) United States
(12) Patent Application Publication
(10) Pub. No.: US 2025/0260066 A1
(43) Pub. Date: Aug. 14, 2025

(54) SOLID-STATE SECONDARY BATTERY AND METHOD OF MANUFACTURING THE SAME

(71) Applicant: HONDA MOTOR CO., LTD., Tokyo (JP)

(72) Inventors: Takashi NAKAGAWA, Saitama (JP); Kyohei IZUMI, Saitama (JP)

(21) Appl. No.: 19/048,981

(22) Filed: Feb. 10, 2025

(30) Foreign Application Priority Data
Feb. 14, 2024 (JP) 2024-020680

(51) Int. Cl. H01M 10/0587; H01M 4/02; H01M 4/36

(52) U.S. Cl. CPC H01M 10/0587; H01M 4/366; H01M 2004/027; H01M 2004/028

(57) ABSTRACT

A solid-state secondary battery according to one embodiment of the present invention includes an electrode laminate that includes a positive electrode layer including a positive electrode active material layer, a solid electrolyte layer, an intermediate layer, and a negative electrode layer, each of the positive electrode layer, the solid electrolyte layer, the intermediate layer, and the negative electrode layer being joined to an adjacent layer, in which a composite modulus of elasticity of each layer of the positive electrode active material layer, the solid electrolyte layer, the intermediate layer, and the negative electrode layer in the electrode laminate satisfies a relationship of intermediate layer<negative electrode layer<solid electrolyte layer<positive electrode active material layer.

This application is based on and claims the benefit of priority from Japanese Patent Application No. 2024-020680, filed on 14 Feb. 2024, the content of which is incorporated herein by reference.

### BACKGROUND OF THE INVENTION

### Field of the Invention

The present invention relates to a solid-state secondary battery, and a method of manufacturing the same.

### Related Art

In recent years, research and development has been carried out on secondary batteries that contribute to energy efficiency in order for more people to be able to ensure access to energy that is reasonable, reliable, sustainable, and advanced. Among secondary batteries, solid-state secondary batteries including an electrode laminate in which a solid electrolyte layer is placed between a positive electrode layer and a negative electrode layer have particularly attracted attention since they are excellent in terms of improved safety thanks to non-flammable solid electrolytes and have higher energy density. To improve the characteristics of the solid-state secondary battery, studies are underway to provide an intermediate layer between a solid electrolyte layer and a negative electrode layer. For example, studies are underway to place a protective layer as an intermediate layer, the protective layer being more stable in reductive decomposition than the solid electrolyte, and having a shearing modulus of elasticity of 2 GPa or more, the shearing modulus of elasticity differing by 50 GPa or less from the shearing modulus of elasticity of the solid electrolyte layer (Patent Document 1).
Patent Document 1: Japanese Unexamined Patent Application, Publication No. 2022-186164

### SUMMARY OF THE INVENTION

Incidentally, in the solid-state secondary battery, it has been desired to increase charge and discharge capacity. TO increase the charge and discharge capacity in the solid-state secondary battery, studies are underway to use lithium as a negative electrode active material and to densify a positive electrode active material layer of a positive electrode layer and a solid electrolyte layer in an electrode laminate. However, in a case where the adhesion at a contact interface between the positive electrode active material layer of the positive electrode layer and the solid electrolyte layer is too low and the joined area is too narrow even when the positive electrode active material layer and the solid electrolyte layer are densified, lithium ions serving as charge transfer media may be deposited at places other than the negative electrode layer during charging. When the charge transfer media are deposited on improper positions during charging, an internal resistance of the electrode laminate increases and an internal short circuit occurs due to electric current concentration, which may cause a decrease in charge and discharge capacity.

The present invention has been made in view of the above-described circumstances, and an object thereof is to provide a solid-state secondary battery in which an increase in internal resistance and an internal short circuit are unlikely to occur, thus achieving a high charge and discharge capacity, and a method of manufacturing the solid-state secondary battery. Consequently, the solid-state secondary battery contributes to energy efficiency.

The present inventors have found that the above-described problems can be solved by, in an electrode laminate including a positive electrode layer, a negative electrode layer, a solid electrolyte layer placed between the positive electrode layer and the negative electrode layer, and an intermediate layer placed between the negative electrode layer and the solid electrolyte layer, adjusting a composite modulus of elasticity of each of the layers when the adjacent layers are joined to each other, thereby completing the present invention.

A first aspect of the present invention relates to a solid-state secondary battery including an electrode laminate that includes a positive electrode layer including a positive electrode current collector and a positive electrode active material layer, a negative electrode layer including a negative electrode current collector facing the positive electrode active material layer, a solid electrolyte layer placed between the positive electrode layer and the negative electrode layer, and an intermediate layer placed between the negative electrode layer and the solid electrolyte layer, each of the positive electrode layer, the solid electrolyte layer, the intermediate layer, and the negative electrode layer being joined to an adjacent layer, in which a composite modulus of elasticity of the positive electrode active material layer before the positive electrode layer and the solid electrolyte layer are joined to each other is less than 30 GPa and a composite modulus of elasticity of the solid electrolyte layer before the joining is less than 15 GPa; a composite modulus of elasticity of the solid electrolyte layer before the solid electrolyte layer and the intermediate layer are joined to each other is less than 18 GPa and a composite modulus of elasticity of the intermediate layer before the joining is less than 1 GPa; and a composite modulus of elasticity of each layer of the positive electrode active material layer, the solid electrolyte layer, the intermediate layer, and the negative electrode layer in the electrode laminate satisfies a relationship of intermediate layer<negative electrode layer<solid electrolyte layer<positive electrode active material layer.

In the solid-state secondary battery of the first aspect, the composite modulus of elasticity of each of the positive electrode layer and the solid electrolyte layer before the joining and the composite modulus of elasticity of each of the solid electrolyte layer and the intermediate layer before the joining fall within the respective ranges described above, and thus the adhesion at the contact interface of each layer in the electrode laminate obtained by joining these layers is enhanced. Therefore, the charge transfer media are deposited on proper positions during charging. The composite modulus of elasticity of each layer in the electrode laminate satisfies the relationship described above, the positive electrode active material layer has the highest composite modulus of elasticity and the high density, and thus the electric capacity of the positive electrode layer is increased. Therefore, in the solid-state secondary battery, an increase in internal resistance and an internal short circuit are unlikely to occur, thus achieving a high charge and discharge capacity.

A second aspect of the present invention relates to the solid-state secondary battery described in the first aspect, in which a relative density of the positive electrode active material layer before the positive electrode layer and the solid electrolyte layer are joined to each other is less than 75% and a relative density of the solid electrolyte layer before the joining is less than 75%, a relative density of the solid electrolyte layer before the solid electrolyte layer and the intermediate layer are joined to each other is less than 85% and a relative density of the intermediate layer before the joining is less than 40%, and among the positive electrode active material layer, the solid electrolyte layer, the intermediate layer, and the negative electrode layer in the electrode laminate, the intermediate layer has a smallest relative density.

In the solid-state secondary battery of the second aspect, the relative density of each of the positive electrode layer and the solid electrolyte layer before the joining and the relative density of each of the solid electrolyte layer and the intermediate layer before the joining fall within the respective ranges described above, and thus the adhesion at the contact interface of each layer in the electrode laminate obtained by joining these layers is further enhanced. Therefore, the charge transfer media are deposited on a more proper position during charging. The relative density of each layer in the electrode laminate satisfies the relationship described above, the positive electrode active material layer has the high relative density, and thus the electric capacity of the positive electrode layer is further increased.

A third aspect of the present invention relates to the solid-state secondary battery described in the first or second aspect, in which each of developed area ratios of contact interfaces between layers including the positive electrode active material layer, the solid electrolyte layer, the intermediate layer, and the negative electrode layer is 0.2 or more.

In the solid-state secondary battery of the third aspect, each of the developed area ratios of contact interfaces between layers in the electrode laminate falls within the range described above, the surface areas of the contact interfaces between layers are large, and thus the adhesion of the contact interfaces between layers in the electrode laminate is further enhanced. Therefore, the charge transfer media are deposited on a more proper position during charging.

A fourth aspect of the present invention relates to the solid-state secondary battery described in any one of the first to third aspects, in which a composite modulus of elasticity of the intermediate layer in the electrode laminate is less than 1 GPa.

In the solid-state secondary battery of the fourth aspect, the composite modulus of elasticity of the intermediate layer having the lowest composite modulus of elasticity among the layers in the electrode laminate falls within the range described above, and thus a reaction area of each of the contact interfaces between the solid electrolyte layer and the intermediate layer and between the negative electrode layer and the intermediate layer can be increased, and the direct current resistance at a large current density can be reduced.

A fifth aspect of the present invention relates to the solid-state secondary battery described in any one of the first to fourth aspects, in which a relative density of the intermediate layer in the electrode laminate falls within a range of 30% or more and 60% or less.

In the solid-state secondary battery of the fifth aspect, the relative density of the intermediate layer falls within the range described above, the intermediate layer is flexible, and thus the intermediate layer can follow changes in the thickness of the negative electrode layer during charging and discharging. Therefore, the internal resistance is stably reduced, thus achieving a stably high charge and discharge capacity. A uniform reaction can be performed in a plane of the electrode and in the thickness direction thereof, and thus the local current concentration can be suppressed, thus contributing to prevention of a short circuit.

A sixth aspect of the present invention relates to the solid-state secondary battery described in any one of the first to fifth aspects, in which the intermediate layer in the electrode laminate includes amorphous carbon particles.

In the solid-state secondary battery of the sixth aspect, the intermediate layer includes the amorphous carbon particles, and thus the conductivity for charge transfer media is enhanced. Therefore, in the electrode laminate, the charge transfer media are deposited on more proper positions during charging.

A seventh aspect of the present invention relates to a solid-state secondary battery including an electrode laminate that includes a positive electrode layer including a positive electrode current collector and a positive electrode active material layer, a negative electrode layer including a negative electrode current collector facing the positive electrode active material layer, a solid electrolyte layer placed between the positive electrode layer and the negative electrode layer, and an intermediate layer placed between the negative electrode layer and the solid electrolyte layer, each of the positive electrode layer, the solid electrolyte layer, the intermediate layer, and the negative electrode layer being joined to an adjacent layer, in which each of developed area ratios of contact interfaces between layers including the positive electrode active material layer, the solid electrolyte layer, the intermediate layer, and the negative electrode layer is 0.2 or more.

In the solid-state secondary battery of the seventh aspect, each of developed area ratios of contact interfaces between layers in the electrode laminate falls within the range described above, the surface areas of the contact interfaces between layers are large, and thus the adhesion of the contact interfaces between layers in the electrode laminate is enhanced. Therefore, in the electrode laminate, the charge transfer media are deposited on proper positions during charging. Therefore, in the solid-state secondary battery, an increase in internal resistance and an internal short circuit are unlikely to occur, thus achieving a high charge and discharge capacity.

An eighth aspect of the present invention relates to the solid-state secondary battery described in the seventh aspect, in which a developed area ratio of a contact interface between the positive electrode active material layer and the solid electrolyte layer is highest, a developed area ratio of a contact interface between the solid electrolyte layer and the intermediate layer is next high, and a developed area ratio of a contact interface between the intermediate layer and the negative electrode layer is lowest.

In the solid-state secondary battery of the eighth aspect, the developed area ratios of the contact interfaces between layers in the electrode laminate satisfy the relationship described above, the surface area of the contact interface between the positive electrode active material layer and the solid electrolyte layer is the largest, and thus the adhesion of the contact interface between the positive electrode active material layer and the solid electrolyte layer is enhanced, making it easy for the charge transfer media to move between the positive electrode active material layer and the solid electrolyte layer. Therefore, the solid-state secondary battery has a lower internal resistance and a higher charge and discharge capacity.

A ninth aspect of the present invention relates to the solid-state secondary battery described in the seventh or eighth aspect, in which a developed area ratio of a contact interface between the positive electrode active material layer and the solid electrolyte layer falls within a range of 1.5 times or more and 3.0 times or less with respect to a developed area ratio of a contact interface between the solid electrolyte layer and the intermediate layer, and the developed area ratio of the contact interface between the solid electrolyte layer and the intermediate layer falls within a range of 2.0 times or more and 5.0 times or less with respect to a developed area ratio of a contact interface between the intermediate layer and the negative electrode layer.

In the solid-state secondary battery of the ninth aspect, the developed area ratio of the contact interface between the positive electrode active material layer and the solid electrolyte layer and the developed area ratio of the contact interface between the solid electrolyte layer and the intermediate layer fall within the respective ranges described above, and thus the adhesion of the contact interface between the positive electrode active material layer and the solid electrolyte layer is further enhanced, making it easy for the charge transfer media to move between the positive electrode active material layer and the solid electrolyte layer. Therefore, the solid-state secondary battery has a lower internal resistance and a higher charge and discharge capacity.

A tenth aspect of the present invention relates to a method of manufacturing a solid-state secondary battery including an electrode laminate that includes a positive electrode layer including a positive electrode current collector and a positive electrode active material layer, a negative electrode layer including a negative electrode current collector facing the positive electrode active material layer, a solid electrolyte layer placed between the positive electrode layer and the negative electrode layer, and an intermediate layer placed between the negative electrode layer and the solid electrolyte layer and in which each of the positive electrode layer, the solid electrolyte layer, the intermediate layer, and the negative electrode layer is joined to an adjacent layer, the method including: a first joining step of joining the positive electrode active material layer and the solid electrolyte layer to obtain a positive electrode layer-solid electrolyte assembly, a second joining step of joining the solid electrolyte layer in the positive electrode layer-solid electrolyte layer assembly and the intermediate layer to obtain a positive electrode layer-solid electrolyte layer-intermediate layer assembly, and a third joining step of joining the intermediate layer in the positive electrode layer-solid electrolyte layer-intermediate layer assembly and the negative electrode layer to obtain the electrode laminate, in which in the first joining step, a composite modulus of elasticity of the positive electrode active material layer before the joining is less than 30 GPa and a composite modulus of elasticity of the solid electrolyte layer before the joining is less than 10 GPa, and in the second joining step, a composite modulus of elasticity of the solid electrolyte layer before the joining is less than 18 GPa and a composite modulus of elasticity of the intermediate layer before the joining is less than 1 GPa.

In the method of manufacturing the solid-state secondary battery of the tenth aspect, the composite modulus of elasticity of each layer to be joined in the first joining step and the second joining step falls within the range described above, and thus the electrode laminate can be obtained in which the adhesion of the contact interfaces between layers is enhanced. Therefore, in the solid-state secondary battery obtained by the method of manufacturing the solid-state secondary battery, an increase in internal resistance and an internal short circuit are unlikely to occur, thus achieving a high charge and discharge capacity.

The present invention makes it possible to provide a solid-state secondary battery in which an increase in internal resistance and an internal short circuit are unlikely to occur, thus achieving a high charge and discharge capacity, and a method of manufacturing the solid-state secondary battery.

### BRIEF DESCRIPTION OF THE DRAWINGS

FIG. 1 is a sectional view illustrating a solid-state secondary battery according to one embodiment of the present invention;

FIG. 2 is a cross-sectional photograph showing a contact interface between a positive electrode active material layer and a solid electrolyte layer in the solid-state secondary battery according to one embodiment of the present invention;

FIG. 3 is a diagram illustrating one step of a method of manufacturing the solid-state secondary battery according to one embodiment of the present invention, the diagram being a sectional view illustrating a state in which the positive electrode layer and the solid electrolyte layer are joined to each other;

FIG. 4 is a diagram illustrating one step of the method of manufacturing the solid-state secondary battery according to one embodiment of the present invention, the diagram being a sectional view illustrating a state in which the solid electrolyte layer and an intermediate layer are joined to each other; and

FIG. 5 is a diagram illustrating one step of the method of manufacturing the solid-state secondary battery according to one embodiment of the present invention, the diagram being a sectional view illustrating a state in which the intermediate layer and a negative electrode layer are joined to each other.

### DETAILED DESCRIPTION OF THE INVENTION

Embodiments of the present invention will be described below with reference to the drawings. It should be noted, however, that the embodiments below are illustrative of the present invention, and the present invention is not limited to the following description.

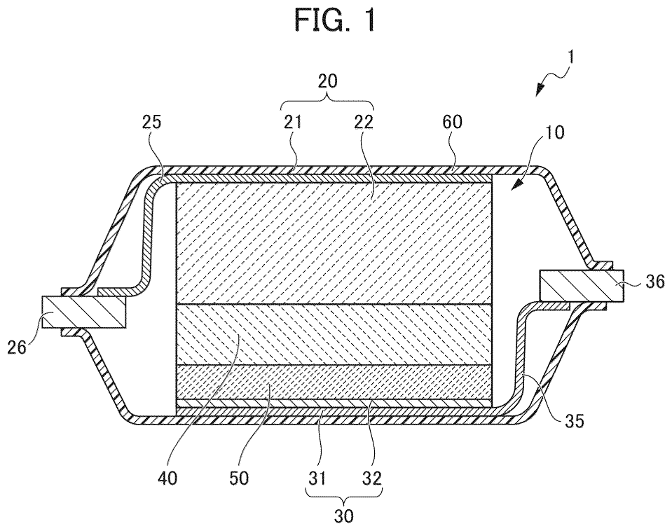

FIG. 1 is a sectional view illustrating a solid-state secondary battery according to one embodiment of the present invention. As illustrated in FIG. 1, a solid-state secondary battery 1 includes an electrode laminate 10, and an exterior housing body 60 housing the electrode laminate 10.

The electrode laminate 10 is a laminate including a positive electrode layer 20, a negative electrode layer 30, a solid electrolyte layer 40 placed between the positive electrode layer 20 and the negative electrode layer 30, and an intermediate layer 50 placed between the negative electrode layer 30 and the solid electrolyte layer 40. The positive electrode layer 20 includes a positive electrode current collector 21, and a positive electrode active material layer 22 laminated on one surface (lower surface in FIG. 1) of the positive electrode current collector 21. The positive electrode current collector 21 is connected to a positive electrode terminal 26 via a positive electrode lead wire 25. The negative electrode layer 30 includes a negative electrode current collector 31, and a metal layer 32 laminated on a surface on the solid electrolyte layer 40 side of the negative electrode current collector 31. The negative electrode current collector 31 is connected to a negative electrode terminal 36 via a negative electrode lead wire 35. The negative electrode current collector 31 faces the positive electrode active material layer 22. Each of the positive electrode layer 20, the solid electrolyte layer 40, the intermediate layer 50, and the negative electrode layer 30 is joined to an adjacent layer. Parts of the positive electrode terminal 26 and the negative electrode terminal 36 are exposed from the exterior housing body 60. The solid-state secondary battery 1 illustrated in FIG. 1 is in a discharged state. When the solid-state secondary battery 1 is charged, lithium ions serving as charge transfer media released from the positive electrode active material layer 22 pass through the solid electrolyte layer 40 and the intermediate layer 50, and are deposited on the surface of the metal layer 32 of the negative electrode layer 30 to generate a lithium deposited layer, resulting in an increase in thickness of the negative electrode layer 30. By passing the lithium ions through the intermediate layer 50, the lithium deposited layer can be uniformly generated on the surface of the metal layer 32. The lithium deposited layer serves as the negative electrode active material, and releases lithium ions during discharging. Therefore, in the solid-state secondary battery 1, the thickness of the negative electrode layer 30 changes due to charging and discharging.

A composite modulus of elasticity of each layer of the positive electrode active material layer 22, the solid electrolyte layer 40, the intermediate layer 50, and the metal layer 32 in the electrode laminate 10 satisfies a relationship of intermediate layer 50<metal layer 32<solid electrolyte layer 40<positive electrode active material layer 22. The composite modulus of elasticity of the intermediate layer 50 may fall, for example, within a range of 0.1 GPa or more and 2.0 GPa or less. The composite modulus of elasticity of the metal layer 32 may fall, for example, within a range of 2 times or more and 10 times or less with respect to the composite modulus of elasticity of the intermediate layer 50. The composite modulus of elasticity of the metal layer 32 may fall, for example, within a range of 1.0 GPa or more and 4.0 GPa or less. The composite modulus of elasticity of the solid electrolyte layer 40 may fall, for example, within a range of 5 times or more and 20 times or less with respect to the composite modulus of elasticity of the metal layer 32. The composite modulus of elasticity of the solid electrolyte layer 40 may fall, for example, within a range of 10 GPa or more and 50 GPa or less. The composite modulus of elasticity of the positive electrode active material layer 22 may fall, for example, within a range of 2 times or more and 5 times or less with respect to the composite modulus of elasticity of the solid electrolyte layer 40. The composite modulus of elasticity of the positive electrode active material layer 22 may fall, for example, within a range of 50 GPa or more and 200 GPa or less. The composite modulus of elasticity is a value measured by the nanoindentation method. The composite modulus of elasticity is a value measured from after the manufacture of the electrode laminate 10 until before the electrode laminate 10 is charged and discharged.

Among the relative densities of the respective layers in the electrode laminate 10, the relative density of the intermediate layer 50 is the smallest. The relative density of the intermediate layer 50 may fall, for example, within a range of 30% or more and 60% or less. The relative density of each of the positive electrode active material layer 22, the solid electrolyte layer 40, and the metal layer 32 may fall, for example, within a range of 1.5 times or more and 3.3 times or less. The relative density of each of the positive electrode active material layer 22, the solid electrolyte layer 40, and the metal layer 32 may be, for example, 95% or more. The relative density is, for example, a value calculated by the following equation (1). In equation (1), the “filling density” can be calculated by measuring the area density and thickness of each layer.

$$Relative density ( \% ) = filling density ( g / cc ) / true density ( g / cc ) \times 100 \qquad ( 1 )$$

The method of calculating the relative density is not limited to the above-described method, and the relative density may be calculated by the BET method, an instrumental analysis using a porosimeter, gas diffusion, or the like, or an image analysis using a scanning electron microscope. The relative density is a value measured from after the manufacture of the electrode laminate 10 until before the electrode laminate 10 is charged and discharged.

The composite modulus of elasticity of the positive electrode active material layer 22 before the positive electrode layer 20 and the solid electrolyte layer 40 are joined to each other is less than 30 GPa, and the composite modulus of elasticity of the solid electrolyte layer 40 is less than 15 GPa. The composite modulus of elasticity and relative density of each of the positive electrode active material layer 22 and the solid electrolyte layer 40 before the joining will be described later in detail.

The composite modulus of elasticity of the solid electrolyte layer 40 before the solid electrolyte layer 40 and the intermediate layer 50 are joined to each other is less than 18 GPa, and the composite modulus of elasticity of the intermediate layer 50 is less than 1 GPa. The composite modulus of elasticity and relative density of each of the solid electrolyte layer 40 and the intermediate layer 50 before the joining will be described later in detail.

Developed area ratios of contact interfaces (Sdr) between layers including the positive electrode active material layer 22, the solid electrolyte layer 40, the intermediate layer 50, and the metal layer 32 in the electrode laminate 10 may each be 0.2 or more, for example. The developed area ratio is the index indicating how much a surface area of the definition region increases with respect to an area of the definition region.

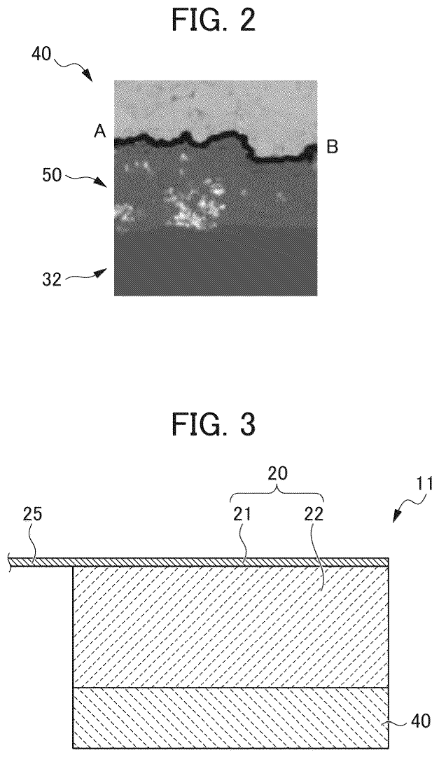

FIG. 2 is a cross-sectional photograph showing a contact interface between the solid electrolyte layer and the intermediate layer in the solid-state secondary battery according to one embodiment of the present invention. A method of measuring the developed area ratio in the present embodiment will be described with reference to FIG. 2, using, as an example, the developed area ratio of the contact interface between the solid electrolyte layer 40 and the intermediate layer 50. Two arbitrary points (A and B in FIG. 2) are set from the cross-sectional photograph showing the solid electrolyte layer 40 and the intermediate layer 50. A linear distance between the two points (hereinafter, referred to as a linear distance between AB) is measured, and a value obtained by squaring the linear length between AB is defined as an area of the definition region. The distance between the two points on the contact interface between the solid electrolyte layer 40 and the intermediate layer 50 (hereinafter, referred to as an interface length between AB) is measured, and a value obtained by squaring the interface length between AB is defined as a surface area of the definition region. The developed area ratio is calculated by the following equation using the obtained area of the definition region [(linear length between AB)²] and the obtained surface area of the definition region [(interface length between AB)²]. Developed area ratio={(interface length between AB)²−(linear length between AB)²}/(linear length between AB)²

Regarding the developed area ratio of each layer in the electrode laminate 10, the developed area ratio of the contact interface between the positive electrode active material layer 22 and the solid electrolyte layer 40 is the highest, the developed area ratio of the contact interface between the solid electrolyte layer 40 and the intermediate layer 50 is next high, and the developed area ratio of the contact interface between the intermediate layer 50 and the metal layer 32 is the lowest. The developed area ratio of the contact interface between the positive electrode active material layer 22 and the solid electrolyte layer 40 may fall, for example, within a range of 1.5 times or more and 3.0 times or less with respect to the developed area ratio of the contact interface between the solid electrolyte layer 40 and the intermediate layer 50. The developed area ratio of the contact interface between the positive electrode active material layer 22 and the solid electrolyte layer 40 may fall, for example, within a range of 2.0 or more and 3.0 or less. The developed area ratio of the contact interface between the solid electrolyte layer 40 and the intermediate layer 50 may fall, for example, within a range of 2.0 times or more and 5.0 times or less with respect to the developed area ratio of the contact interface between the intermediate layer 50 and the metal layer 32. The developed area ratio of the contact interface between the solid electrolyte layer 40 and the intermediate layer 50 may fall, for example, within a range of 1.0 or more and 2.0 or less. The developed area ratio of the contact interface between the intermediate layer 50 and the metal layer 32 may fall, for example, within a range of 0.1 or more and 1.0 or less.

The positive electrode current collector 21 may have any material and shape as long as it has the function of collecting current from the positive electrode layer 20. Examples of the material of the positive electrode current collector 21 include aluminum, an aluminum alloy, stainless steel, nickel, iron, and titanium, and among them, aluminum, an aluminum alloy, and stainless steel are preferable. Examples of the shape of the positive electrode current collector 21 include a foil shape, and a plate shape.

The positive electrode active material layer 22 contains at least one type of positive electrode active material. The positive electrode active material is not limited to particular one, and a positive electrode active material which is used in the positive electrode layer in a general solid-state secondary battery can be used. Examples of the positive electrode active material which can be used include a lithium-containing layered active material, a spinel-type active material, and an olivine-type active material. Specific examples of the positive electrode active material include lithium cobalt oxide (LiCoO₂), lithium nickel oxide (LiNiO₂), LiNiₚMn_{q}CoᵣO₂ (p+q+r=1), LiNiₚAl_{q}CoᵣO₂ (p+q+r=1), lithium manganate (LiMn₂O₄), a different element substituted Li—Mn spinel represented by Li₁₊ₓMn_{2-x-y}Mo₄ (x+Y=2, M=at least one selected from Al, Mg, Co, Fe, Ni, and Zn), lithium titanate (oxide including Li and Ti), and lithium metal phosphate (LiMPO₄, M=at least one selected from Fe, Mn, Co and Ni).

The average particle size of the positive electrode active material may fall, for example within a range of 1 μm or more and 20 μm or less. In the present embodiment, the average particle size is a value measured by the laser diffraction and scattering method.

In terms of enhancing the conductivity for lithium ions, the positive electrode active material layer 22 may arbitrarily include a solid electrolyte. The positive electrode active material layer 22 may arbitrarily include a conductive aid to enhance the conductivity. Furthermore, in terms of developing the flexibility, the positive electrode active material layer 22 may arbitrarily include a binder. The solid electrolyte, the conductive air, and the binder are not limited to particular ones, and a solid electrolyte, a conductive aid, and a binder which are used in the positive electrode layer in a general solid-state secondary battery can be used.

The positive electrode lead wire 25 may be made of the same material as the positive electrode current collector 21, or may be made of a material different from the positive electrode current collector 21. The positive electrode lead wire 25 may be integrally connected to the positive electrode current collector 21. In the present embodiment, the positive electrode lead wire 25 is formed as an extension of the positive electrode current collector 21, and is integrally connected to the positive electrode current collector 21. The positive electrode terminal 26 may be made of the same material as the positive electrode lead wire 25, or may be made of a material different from the positive electrode lead wire 25. The positive electrode terminal 26 may be integrally connected to the positive electrode lead wire 25. In the present embodiment, the positive electrode terminal 26 and the positive electrode lead wire 25 are different members electrically connected to each other.

The negative electrode current collector 31 may have any material and shape as long as it has the function of collecting current from the negative electrode layer 30. Examples of the material of the negative electrode current collector 31 include nickel, copper, and stainless steel. Examples of the shape of the negative electrode current collector 31 include a foil shape, and a plate shape.

The metal layer 32 may have any material and shape as long as it has the function of densely depositing lithium ions. As the metal layer 32, metallic lithium layer or a layer of metal which generates an alloy with lithium can be used. Examples of the metal which forms an alloy with lithium include Mg, Si, Au, Ag, In, Ge, Sn, Pb, Al, and Zn. The metal which forms the metal layer 32 may be in the shape of powder or may be in the shape of a thin film. The negative electrode layer 30 which includes this metal layer 32 is used, and thus the lithium deposited layer can be uniformly generated on the surface of the metal layer 32.

The negative electrode lead wire 35 may be made of the same material as the negative electrode current collector 31, or may be made of a material different from the negative electrode current collector 31. The negative electrode lead wire 35 may be integrally connected to the negative electrode current collector 31. In the present embodiment, the negative electrode lead wire 35 is formed as an extension of the negative electrode current collector 31, and is integrally connected to the negative electrode current collector 31. The negative electrode terminal 36 may be made of the same material as the negative electrode lead wire 35, or may be made of a material different from the negative electrode lead wire 35. The negative electrode terminal 36 may be integrally connected to the negative electrode lead wire 35. In the present embodiment, the negative electrode terminal 36 and the negative electrode lead wire 35 are different members electrically connected to each other.

The solid electrolyte layer 40 contains at least one type of solid electrolyte. The solid electrolyte layer 40 can conduct the lithium ions between the positive electrode layer 20 and the negative electrode layer 30 via the solid electrolyte.

Although the solid electrolyte is not limited to particular one as long as it has the conductivity for lithium ions, examples of the solid electrolyte which can be used include a sulfide solid electrolyte, an oxide solid electrolyte, a nitride solid electrolyte, and a halide solid electrolyte.

Examples of the sulfide solid electrolyte include Li₂S—P₂S₅, and Li₂S—P₂S₅—LiI. The sulfide solid electrolyte may have an argyrodite type crystal structure.

Examples of the oxide solid electrolyte include a NASICON type oxide, a garnet type oxide, and a perovskite type oxide. Examples of the NASICON type oxide include oxides containing Li, Al, Ti, P, and O (for example, Li_{1.5}Al_{0.5}Ti_{1.5}(PO₄)₃). Examples of the garnet type oxide include oxides containing Li, La, Zr, and O (for example, Li₇La₃Zr₂O₁₂). Examples of the perovskite type oxide include oxides containing Li, La, Ti, and O (for example, LiLaTiO₃).

The average particle size of the solid electrolyte included in the solid electrolyte layer 40 is equivalent to or smaller than the average particle size of the positive electrode active material included in the positive electrode active material layer 22. A ratio D50_{SE}/D50_{Cathode} between the average particle size D50_{SE} of the solid electrolyte and the average particle size D50_{Cathode} of the positive active material may fall within a range of more than 0.1 and 1.0 or less. The average particle size of the solid electrolyte may fall, for example, within a range of 0.5 μm or more and 10 μm or less.

The solid electrolyte layer 40 may include a binder. The binder is not limited to particular one, and a binder which is used in the solid electrolyte layer in a general solid-state secondary battery can be used.

The solid electrolyte layer 40 may has an inner porous substrate. As the porous substrate, for example, a woven or nonwoven fabric can be used. The solid electrolyte having an inner porous substrate has high strength.

The intermediate layer 50 has electron conductivity, and pores through which lithium metal can pass. The intermediate layer 50 with such pores has such a degree of flexibility that it can follow changes in the thickness of the negative electrode layer 30 during charging and discharging. Therefore, even when the solid-state secondary battery 1 is repeatedly charged and discharged, the interfacial adhesion of each layer in the electrode laminate 10 can be maintained, and the durability of the solid-state secondary battery 1 can be enhanced.

The intermediate layer 50 may include a material having the conductivity for the lithium metal and a material having the electron conductivity. As the material having the conductivity for the lithium metal, for example, amorphous carbon particles can be used. As the material having the electron conductivity, for example, a metal can be used. The metal may be in the form of particles. The metal particles may be included in the intermediate layer 50 in the state of a mixture with the amorphous carbon particles, or may be included in the intermediate layer 50 in the state of being supported on the amorphous carbon particles. The metal may be placed, in a form of film, on each surface of the amorphous carbon particles, or the amorphous carbon particles may be impregnated with the metal.

As the amorphous carbon particles, for example, easily graphitizable carbon (soft carbon) or hardly graphitizable carbon (hard carbon) can be used. Specific examples of the amorphous carbon particles include carbon blacks such as acetylene black, furnace black, and Ketjen black, coke, activated carbon, carbon nanotube (CNT), fullerene, and graphene. Some of carbon atoms in the amorphous carbon particles are substituted with atoms such as B, P, S, O, and N by a chemical treatment such as a gas phase method or a liquid phase method.

As the metal included in the intermediate layer 50, particles in a range of a metal which forms an alloy with lithium or an intermetallic compound can be used. Examples of the metal which forms an alloy with lithium ions or an intermetallic compound include Ag, Au, Pt, Pd, Si, Al, Bi, Sn, Zn, Ga, and In.

When the intermediate layer 50 includes a mixture of the amorphous carbon particles and the metal particles, the average particle size of the mixture may be smaller than the average particle size of the solid electrolyte included in the solid electrolyte layer 40. In this way, the intermediate layer 50 can enter a gap between the solid electrolytes which are present on the interface of the solid electrolyte layer 40, and thus the developed area ratio of a contact interface between the solid electrolyte layer 40 and the intermediate layer 50 can be increased and the adhesion between the solid electrolyte layer 40 and the intermediate layer 50 can be enhanced. The average particle size of the amorphous carbon particles may fall, for example within a range of 0.02 μm or more and 0.06 μm or less. The average particle size of the metal particles may fall, for example within a range of 0.06 μm or more and 0.1 μm or less.

The exterior housing body 60 can be expanded and contracted as the thickness of the negative electrode layer 30 is changed by charging and discharging. As the material of the exterior housing body 60, a laminate film can be used. As the laminate film, a laminate film having a three-layer structure can be used in which an inner resin layer, a metal layer, and an outer resin layer are laminated in this order from the inside. The outer resin layer may be, for example, a polyamide (nylon) layer, or a polyethylene terephthalate (PET) layer, the metal layer may be, for example, an aluminum layer, and the inner resin layer may be, for example, a polyethylene layer, or a polypropylene layer.

A method of manufacturing the solid-state secondary battery 1 in the present embodiment will be described. FIGS. 3 to 5 each are a diagram illustrating one step of a method of manufacturing the solid-state secondary battery according to one embodiment of the present invention. The method of manufacturing the solid-state secondary battery 1 in the present embodiment includes three joining steps of a first joining step, a second joining step, and a third joining step.

In the first joining step, as illustrated in FIG. 3, the positive electrode layer 20 with the positive electrode lead wire 25 and the solid electrolyte layer 40 are joined to each other to obtain a positive electrode layer-solid electrolyte layer assembly 11. In the first joining step, the composite modulus of elasticity of the positive electrode active material layer 22 before the joining is less than 30 GPa, and the composite modulus of elasticity of the solid electrolyte layer 40 before the joining is less than 10 GPa. The composite modulus of elasticity of the positive electrode active material layer 22 before the joining may fall, for example, within a range of 0.09 GPa or more and 20 GPa or less. The composite modulus of elasticity of the solid electrolyte layer 40 before the joining may fall, for example, within a range of 0.06 GPa or more and 8 GPa or less. The composite modulus of elasticity of the solid electrolyte layer 40 before the joining may be equivalent to or different from the composite modulus of elasticity of the positive electrode active material layer 22 before the joining. The composite modulus of elasticity of the solid electrolyte layer 40 before the joining may fall, for example, within a range of 0.01 times or more and 100 times or less with respect to the composite modulus of elasticity of the positive electrode active material layer 22 before the joining.

The relative density of the positive electrode active material layer 22 before the positive electrode layer 20 and the solid electrolyte layer 40 are joined to each other may be less than 75%, and the relative density of the solid electrolyte layer 40 before the joining may be less than 75%. The relative density of the positive electrode active material layer 22 before the joining may fall, for example, within a range of 50% or more and 70% or less. The relative density of the solid electrolyte layer 40 before the joining may fall, for example, within a range of 50% or more and 70% or less. The relative density of the solid electrolyte layer 40 before the joining may be equivalent to or different from the relative density of the positive electrode active material layer 22 before the joining. The relative density of the solid electrolyte layer 40 before the joining may fall, for example, within a range of 0.7 times or more and 1.4 times or less with respect to the relative density of the positive electrode active material layer 22 before the joining.

As a method of joining the positive electrode layer 20 and the solid electrolyte layer 40, for example, a press method can be used. As a press machine, for example, a roll press machine can be used. The joining conditions such as a joining pressure, joining time, and a joining temperature are, for example, the conditions under which the composite modulus of elasticity of the solid electrolyte layer 40 after the joining is less than 18 GPa. The press conditions may be, for example, the conditions under which the ratio of the relative density of the solid electrolyte layer 40 after the joining with respect to the relative density of the solid electrolyte layer 40 before the joining (relative density after joining/relative density before joining) falls within a range of 1.05 or more and 1.5 or less, or the ratio of the composite modulus of elasticity of the solid electrolyte layer 40 after the joining with respect to the composite modulus of elasticity of the solid electrolyte layer 40 before the joining (composite modulus of elasticity after joining/composite modulus of elasticity before joining) falls within a range of 20 or more and 150 or less.

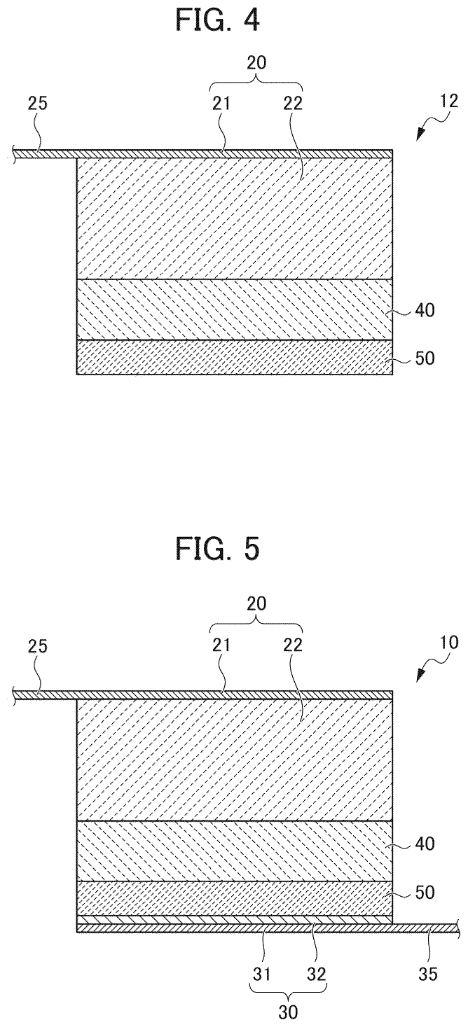

In the second joining step, as illustrated in FIG. 4, the solid electrolyte layer 40 in the positive electrode layer-solid electrolyte layer assembly 11 and the intermediate layer 50 are joined to each other to obtain a positive electrode layer-solid electrolyte layer-intermediate layer assembly 12. In the second joining step, the composite modulus of elasticity of the solid electrolyte layer 40 before the joining is less than 18 GPa, and the composite modulus of elasticity of the intermediate layer 50 before the joining is less than 1 GPa. The composite modulus of elasticity of the solid electrolyte layer 40 before the joining may fall, for example, within a range of 5 GPa or more and 15 GPa or less. The composite modulus of elasticity of the intermediate layer 50 before the joining may fall, for example, within a range of 0.05 GPa or more and 0.4 GPa or less. The composite modulus of elasticity of the solid electrolyte layer 40 before the joining may be higher than the composite modulus of elasticity of the intermediate layer 50 before the joining. The composite modulus of elasticity of the solid electrolyte layer 40 before the joining may fall, for example, within a range of 20 times or more and 200 times or less with respect to the composite modulus of elasticity of the intermediate layer 50 before the joining.

The relative density of the solid electrolyte layer 40 before the solid electrolyte layer 40 and the intermediate layer 50 are joined to each other may be less than 85%, and the relative density of the intermediate layer 50 before the joining may be less than 40%. The relative density of the solid electrolyte layer 40 before the joining may fall, for example, within a range of 60% or more and 80% or less. The relative density of the intermediate layer 50 before the joining may fall, for example, within a range of 10% or more and 30% or less. The relative density of the solid electrolyte layer 40 before the joining may be higher than the relative density of the intermediate layer 50 before the joining. The relative density of the solid electrolyte layer 40 before the joining may fall, for example, within a range of 2 times or more and 8 times or less with respect to the relative density of the intermediate layer 50 before the joining.

As a method of joining the solid electrolyte layer 40 and the intermediate layer 50, for example, a press method can be used. As a press machine, for example, a roll press machine can be used. The press conditions such as a joining pressure, joining time, and a joining temperature may be, for example, the conditions under which the ratio of the relative density of the intermediate layer 50 after the joining with respect to the relative density of the intermediate layer 50 before the joining (relative density after joining/relative density before joining) falls within a range of 1.3 or more and 4.5 or less, or the ratio of the composite modulus of elasticity of the intermediate layer 50 after the joining with respect to the composite modulus of elasticity of the intermediate layer 50 before the joining (composite modulus of elasticity after joining/composite modulus of elasticity before joining) falls within a range of 2 or more and 10 or less. The press conditions may be, for example, the conditions under which the composite modulus of elasticity of the intermediate layer 50 after the joining is less than 1 GPa or the conditions under which the relative density of the intermediate layer 50 after the joining falls within a range of 30% or more and 60% or less.

In the third joining step, as illustrated in FIG. 5, the intermediate layer 50 in the positive electrode layer-solid electrolyte layer-intermediate layer assembly 12 and the negative electrode layer 30 with the negative electrode lead wire 35 are joined to each other to obtain the electrode laminate 10. The composite modulus of elasticity of the intermediate layer 50 before the joining may be less than 1.0 GPa, and the composite modulus of elasticity of the metal layer 32 may be less than 5.0 GPa. The composite modulus of elasticity of the intermediate layer 50 before the joining may fall, for example, within a range of 0.05 GPa or more and 0.9 GPa or less. The composite modulus of elasticity of the metal layer 32 before the joining may fall, for example, within a range of 0.05 GPa or more and 10 GPa or less. The composite modulus of elasticity of the metal layer 32 before the joining may be higher than the composite modulus of elasticity of the intermediate layer 50 before the joining. The composite modulus of elasticity of the metal layer 32 before the joining may fall, for example, within a range of 2 times or more and 100 times or less with respect to the composite modulus of elasticity of the intermediate layer 50 before the joining.

The relative density of the intermediate layer 50 before the intermediate layer 50 and the negative electrode layer 30 are joined to each other may be less than 40%, and the relative density of the metal layer 32 before the joining may be 95% or more. The relative density of the intermediate layer 50 before the joining may fall, for example, within a range of 30% or more and 50% or less.

As a method of joining the intermediate layer 50 and the negative electrode layer 30, for example, a press method can be used. As a press machine, for example, a roll press machine can be used. The press conditions such as a joining pressure, joining time, and a joining temperature may be, for example, the conditions under which the ratio of the relative density of the intermediate layer 50 after the joining with respect to the relative density of the intermediate layer 50 before the joining (relative density after joining/relative density before joining) falls within a range of 1.0 or more and 2.0 or less, or the ratio of the composite modulus of elasticity of the intermediate layer 50 after the joining with respect to the composite modulus of elasticity of the intermediate layer 50 before the joining (composite modulus of elasticity after joining/composite modulus of elasticity before joining) falls within a range of 2 or more and 5 or less. The press conditions may be, for example, the conditions under which the composite modulus of elasticity of the intermediate layer 50 after the joining is less than 1 GPa or the conditions under which the relative density of the intermediate layer 50 after the joining falls within a range of 30% or more and 60% or less.

By the above-described manufacturing method, the electrode laminate 10 is obtained which includes the positive electrode layer 20 including the positive electrode current collector 21 and the positive electrode active material layer 22, the negative electrode layer 30 including the negative electrode current collector 31 facing the positive electrode active material layer 22, the solid electrolyte layer 40 placed between the positive electrode layer 20 and the negative electrode layer 30, and the intermediate layer 50 placed between the negative electrode layer 30 and the solid electrolyte layer 40, in which each of the positive electrode layer 20, the solid electrolyte layer 40, the intermediate layer 50, and the negative electrode layer 30 is joined to an adjacent layer. The obtained electrode laminate 10 may be arbitrarily pressed in the laminating direction such that each layer of the electrode laminate 10 is densified.

The solid-state secondary battery 1 can be manufactured as follows. The positive electrode terminal 26 is connected to the positive electrode lead wire 25 of the obtained electrode laminate 10, and the negative electrode terminal 36 is connected to the negative electrode lead wire 35 of the electrode laminate 10. Then, the electrode laminate 10 is housed in the exterior housing body 60 and the exterior housing body 60 is sealed such that the end portions of the positive electrode terminal 26 and the negative electrode terminal 36 protrude.

In the solid-state secondary battery 1 of the present embodiment configured as described above, the composite modulus of elasticity of each of the positive electrode layer 20 and the solid electrolyte layer 40 before the joining and the composite modulus of elasticity of each of the solid electrolyte layer 40 and the intermediate layer 50 before the joining fall within the respective ranges described above, and thus the adhesion at the contact interface of each layer in the electrode laminate 10 obtained by joining these layers is enhanced. Therefore, the lithium is likely to be deposited on the metal layer 32 of the negative electrode layer 30 during charging, so that the lithium can be deposited on a proper position during charging. The composite modulus of elasticity of each layer in the electrode laminate 10 satisfies the relationship described above, the positive electrode active material layer 22 is a layer having the highest composite modulus of elasticity and the high density, and thus the electric capacity of the positive electrode layer 20 is increased. Therefore, in the solid-state secondary battery 1, an increase in internal resistance and an internal short circuit are unlikely to occur, thus achieving a high charge and discharge capacity.

In the solid-state secondary battery 1, in a case where the relative density of each of the positive electrode layer 20 and the solid electrolyte layer 40 before the joining and the relative density of each of the solid electrolyte layer 40 and the intermediate layer 50 before the joining fall within the respective ranges described above, the adhesion at the contact interface of each layer in the electrode laminate 10 obtained by joining these layers is further enhanced. Therefore, the lithium is deposited on a more proper position during charging. The relative density of each layer in the electrode laminate 10 satisfies the relationship described above, and the positive electrode active material layer 22 has the high relative density, and thus the electric capacity of the positive electrode layer 20 is increased.

In the solid-state secondary battery 1, in a case where the relative density of the intermediate layer 50 falls within the range described above, and the intermediate layer 50 is flexible, and thus the intermediate layer 50 can follow changes in the thickness of the negative electrode layer 30 during charging and discharging. Therefore, the internal resistance is stably reduced, thus achieving a stably high charge and discharge capacity. In a case where the intermediate layer 50 includes the amorphous carbon particles, the conductivity for the lithium is enhanced. Therefore, in the electrode laminate 10, the lithium is deposited on a more proper position during charging.

In the solid-state secondary battery 1, in a case where each of the developed area ratios of contact interfaces between layers in the electrode laminate 10 falls within the range described above, the surface areas of the contact interfaces between layers are large, and thus the adhesion of the contact interfaces between layers in the electrode laminate 10 is enhanced. Therefore, in the electrode laminate 10, the lithium is deposited on a proper position during charging. Therefore, in the solid-state secondary battery 1, an increase in internal resistance and an internal short circuit are unlikely to occur, thus achieving a high charge and discharge capacity.

In the solid-state secondary battery 1, in a case where each of the developed area ratios of contact interfaces between layers in the electrode laminate 10 falls within the range described above, the surface area of the contact interface between the positive electrode active material layer 22 and the solid electrolyte layer 40 is large, and thus the adhesion of the contact interface between the positive electrode active material layer 22 and the solid electrolyte layer 40 is enhanced, making it easy for the lithium to move between the positive electrode active material layer 22 and the solid electrolyte layer 40. Therefore, in the solid-state secondary battery 1, the internal resistance is further decreased, thus achieving a higher charge and discharge capacity.

In the solid-state secondary battery 1, the developed area ratio of the contact interface between the positive electrode active material layer 22 and the solid electrolyte layer 40 and the developed area ratio of the contact interface between the solid electrolyte layer 40 and the intermediate layer 50 fall within the respective ranges described above, and thus the adhesion of the contact interface between the positive electrode active material layer 22 and the solid electrolyte layer 40 is further enhanced, making it easy for the lithium ions to move between the positive electrode active material layer 22 and the solid electrolyte layer 40. Therefore, in the solid-state secondary battery 1, the internal resistance is further decreased, thus achieving a higher charge and discharge capacity.

In the method of manufacturing the solid-state secondary battery 1 of the present embodiment, the composite modulus of elasticity of each layer to be joined in the first joining step and the second joining step falls within the range described above, and thus the electrode laminate 10 can be obtained in which the adhesion of the contact interfaces between layers is enhanced. Therefore, in the solid-state secondary battery 1 obtained by the method of manufacturing the solid-state secondary battery 1 of the present embodiment, an increase in internal resistance and an internal short circuit are unlikely to occur, thus achieving a high charge and discharge capacity.

Although the embodiment of the present invention has been described above, the present invention is not limited to the embodiment described above. For example, although in the solid-state secondary battery 1 of the present embodiment, the negative electrode layer 30 includes the metal layer 32, the metal layer 32 may be omitted so that the lithium can be deposited on the surface of the negative electrode current collector 31. Instead of the metal layer 32, a layer may be used which includes a negative electrode active material capable of absorbing and releasing lithium ions. Examples of the negative electrode active material include lithium transition metal oxides such as lithium titanate, transition metal oxides such as TiO₂, Nb₂O₃, and Won, Si, SiO, metal sulfides, metal nitrides, and carbon materials such as artificial graphite, natural graphite, graphite, soft carbon and hard carbon. In terms of enhancing the conductivity for the lithium ions, the negative electrode active material layer may arbitrarily include a solid electrolyte. The negative electrode active material layer may arbitrarily include a conductive aid to enhance the conductivity. Furthermore, in terms of developing the flexibility, the negative electrode active material layer may arbitrarily include a binder. As the solid electrolyte, the conductive aid and the binder, a solid electrolyte, a conductive aid, and a binder which are used in a general solid-state secondary battery can be used.

The solid-state secondary battery 1 of the present embodiment is a lithium battery using lithium as the charge transfer medium, but the present invention is not limited thereto. The solid-state secondary battery 1 of the present embodiment may be, for example, a battery using sodium, potassium, magnesium, calcium, aluminum, zinc, and fluorine as the charge transfer media.

### EXAMPLES

The present invention will be described in detail below using Examples. However, the present invention is not limited to Examples below.

### Example 1

### (Production of Positive Electrode Layer)

As a positive electrode current collector with a positive electrode lead wire, an aluminum foil having a thickness of 15.0 μm was prepared. A mixture was prepared of 80 parts by mass of lithium-nickel-cobalt-manganese composite oxide (NCM622) as a positive electrode active material, 17 parts by mass of an argyrodite type sulfide solid electrolyte as a solid electrolyte, 2 parts by mass of carbon black as a conductive aid, and 1 part by mass of styrene-butadiene rubber (SBR) type binder as a binder. The resulting mixture was dispersed in 43 parts by mass of butyl butyrate to prepare a positive electrode active material layer slurry. The resulting positive electrode active material layer slurry was applied on one surface of the positive electrode current collector using a bar coater such that the coating weight after drying was 27 mg/cm² and then dried to form a positive electrode active material layer having a thickness of 80.0 μm, so that a positive electrode layer was produced. The relative density of the positive electrode active material layer was 55%, and the composite modulus of elasticity thereof was 0.1 GPa.

### (Production of Solid Electrolyte Layer Transfer Sheet)

A dispersion liquid of an argyrodite type sulfide solid electrolyte (average particle size: 3.0 μm) was applied on a support sheet and then dried to form an argyrodite type sulfide solid electrolyte layer having a thickness of 100 μm, so that a solid electrolyte layer transfer sheet was produced. The relative density of the solid electrolyte layer was 60%, and the composite modulus of elasticity thereof was 0.2 GPa.

### (Production of Intermediate Layer Transfer Sheet)

A mixture was prepared of 95 parts by mass in total of Sn particles (average particle size: 0.07 μm) as metal particles and acetylene black (average particle size: 0.05 μm) as amorphous carbon particles, and 5 parts by mass of a PVDF type binder as a binder. The resulting mixture was dispersed in 1,000 parts by mass of N-methyl-2-pyrrolidone (NMP) to prepare an intermediate layer slurry. The resulting intermediate layer slurry was applied on a support sheet and then dried to produce an intermediate layer transfer sheet such that a final thickness was 3.0 μm. The relative density of the intermediate layer was 18%, and the composite modulus of elasticity thereof was 0.1 GPa.

### (Production of Negative Electrode Layer)

As a negative electrode current collector with a negative electrode lead wire, a copper foil having a thickness of 10 μm was prepared. A metallic lithium foil having a thickness of 40 μm, a relative density of 98%, and a composite modulus of elasticity of 2.0 GPa was rolled and laminated on the surface of the copper foil to produce a negative electrode layer.

### (Production of Electrode Laminate)

The solid electrolyte layer of the solid electrolyte layer transfer sheet was superimposed on the surface of the positive electrode active material layer of the positive electrode layer, and the solid electrolyte layer and the positive electrode active material layer were joined using a uniaxial molding press device under the joining conditions of a joining pressure of 90 MPa, joining time of 3 minutes, and a joining temperature of room temperature (first joining step). Then, the support sheet was peeled off from the solid electrolyte layer transfer sheet to obtain a positive electrode layer-solid electrolyte layer assembly. Next, the intermediate layer of the intermediate layer transfer sheet was superimposed on the surface of the solid electrolyte layer in the positive electrode layer-solid electrolyte layer assembly, and the intermediate layer and the solid electrolyte layer were joined using a uniaxial molding press device under the joining conditions of a joining pressure of 290 MPa, joining time of 5 minutes, and a joining temperature of room temperature (second joining step). Then, the support sheet was peeled off from the intermediate layer transfer sheet to obtain a positive electrode layer-solid electrolyte layer-intermediate layer assembly. Next, using an isostatic molding press device, an integrated unit of the positive electrode layer-solid electrolyte layer-intermediate layer assembly was subjected to the densifying treatment under the conditions of a joining pressure of 980 MPa, joining time of 5 minutes, and a joining temperature of 120° C. Next, the metallic lithium foil of the negative electrode layer was superimposed on the surface of the intermediate layer in the positive electrode layer-solid electrolyte layer-intermediate layer assembly, and the metallic lithium foil and the intermediate layer were joined using a uniaxial molding press device under the joining conditions of a joining pressure of 180 MPa, joining time of 2 minutes, and a joining temperature of room temperature (third joining step). In this way, an electrode laminate was obtained. The relative density and the composite modulus of elasticity of each of the positive electrode active material layer and the solid electrolyte layer before the positive electrode layer and the solid electrolyte layer were joined to each other, the relative density and the composite modulus of elasticity of each of the solid electrolyte layer and the intermediate layer before the solid electrolyte layer and the intermediate layer were joined to each other, and the relative density and the composite modulus of elasticity of each of the intermediate layer and the metallic lithium foil before the intermediate layer and the negative electrode layer were joined to each other are shown in Table 1 described below. The relative density and the composite modulus of elasticity of each layer in the electrode laminate are shown in Table 2 described below.

### Examples 2 to 3

An electrode laminate was obtained in the same manner as in Example 1 except that the press conditions when the positive electrode layer and the solid electrolyte layer were joined to each other and the press conditions when the solid electrolyte layer and the intermediate layer were joined to each other were changed such that the composite modulus of elasticity of the solid electrolyte layer before the solid electrolyte layer and the intermediate layer were joined to each other and the relative density and the composite modulus of elasticity of the intermediate layer before the intermediate layer and the negative electrode layer were joined to each other became values shown in Table 1 described below. The relative density and the composite modulus of elasticity of each layer in the electrode laminate are shown in Table 2 described below.

### Comparative Example 1

An electrode laminate was obtained in the same manner as in Example 1 except that before the positive electrode layer and the solid electrolyte layer were joined to each other, the positive electrode layer was pressed such that the relative density and the composite modulus of elasticity of the positive electrode active material layer were changed to become the values shown in Table 1 described below. The relative density and the composite modulus of elasticity of each layer in the electrode laminate are shown in Table 2 described below.

### Comparative Example 2

An electrode laminate was obtained in the same manner as in Example 1 except that before the positive electrode layer and the solid electrolyte layer were joined to each other, the solid electrolyte layer transfer sheet was pressed such that the relative density and the composite modulus of elasticity of the solid electrolyte layer were changed to become the values shown in Table 1 described below, and the relative density and the composite modulus of elasticity of the solid electrolyte layer before the solid electrolyte layer and the intermediate layer were joined to each other were changed. The relative density and the composite modulus of elasticity of each layer in the electrode laminate are shown in Table 2 described below.

### Comparative Example 3

An electrode laminate was obtained in the same manner as in Example 1 except that the solid electrolyte layer and the metallic lithium foil of the negative electrode layer were directly joined to each other without joining the intermediate layer to the solid electrolyte. The relative density and the composite modulus of elasticity of each layer in the electrode laminate are shown in Table 2 described below.

TABLE 1

| | Before positive electrode layer and solid | | | | | |
|---|---|---|---|---|---|---|
| | electrolyte layer are joined to each other | | | | Before solid electrolyte layer and | |
| | | | Composite modulus of | | intermediate layer are joined to each other | |
| | Relative density (%) | | elasticity (GPa) | | Relative density (%) | |
| | Positive | Solid | Positive | Solid | Solid | |
| | electrode active | electrolyte | electrode active | electrolyte | electrolyte | Intermediate |
| | material layer | layer | material layer | layer | layer | layer |
| Example 1 | 55 | 60 | 0.1 | 0.2 | 65 | 18 |
| Example 2 | 55 | 60 | 0.1 | 0.2 | 65 | 18 |
| Example 3 | 55 | 60 | 0.1 | 0.2 | 65 | 18 |
| Comparative | 76 | 60 | 33.0 | 0.2 | 65 | 18 |
| Example 1 | | | | | | |
| Comparative | 55 | 78 | 0.1 | 18 | 90 | 18 |
| Example 2 | | | | | | |
| Comparative | 55 | 60 | 0.1 | 0.2 | 87 | 18 |
| Example 3 | | | | | | |
| Comparative | 55 | 60 | 0.1 | 0.2 | — | — |
| Example 4 | | | | | | |

| | Before solid electrolyte layer and | | Before intermediate layer and negative | | | |
|---|---|---|---|---|---|---|
| | intermediate layer are joined to each other | | electrode layer are joined to each other | | | |
| | Composite modulus of | | | | Composite modulus of | |
| | elasticity (GPa) | | Relative density (%) | | elasticity (GPa) | |
| | Solid | | | Metallic | | Metallic |
| | electrolyte | Intermediate | Intermediate | lithium | Intermediate | lithium |
| | layer | layer | layer | foil | layer | foil |
| Example 1 | 5.9 | 0.1 | 43 | 98 | 0.8 | 2.0 |
| Example 2 | 5.8 | 0.1 | 40 | 98 | 0.7 | 2.0 |
| Example 3 | 6.0 | 0.1 | 44 | 98 | 0.6 | 2.0 |
| Comparative | 5.9 | 0.1 | 43 | 98 | 0.8 | 2.0 |
| Example 1 | | | | | | |
| Comparative | 21 | 0.1 | 43 | 98 | 0.8 | 2.0 |
| Example 2 | | | | | | |
| Comparative | 19 | 0.1 | 43 | 98 | 0.8 | 2.0 |
| Example 3 | | | | | | |
| Comparative | — | — | — | — | — | — |
| Example 4 | | | | | | |

TABLE 2

| | Properties of each layer in electrode laminate | | | | | | | |
|---|---|---|---|---|---|---|---|---|
| | Relative density (%) | | | | Composite modulus of elasticity (GPa) | | | |
| | Positive | | | | Positive | | | |
| | electrode | | | | electrode | | | |
| | active | Solid | | Negative | active | Solid | | Negative |
| | material | electrolyte | Intermediate | electrode | material | electrolyte | Intermediate | electrode |
| | layer | layer | layer | layer | layer | layer | layer | layer |
| Example 1 | 98 | 98 | 43 | 98 | 98 | 25 | 0.8 | 2.0 |
| Example 2 | 98 | 98 | 40 | 98 | 98 | 25 | 0.7 | 2.0 |
| Example 3 | 98 | 98 | 44 | 98 | 98 | 25 | 0.6 | 2.0 |
| Comparative | 98 | 98 | 43 | 98 | 98 | 25 | 0.8 | 2.0 |
| Example 1 | | | | | | | | |
| Comparative | 98 | 98 | 43 | 98 | 98 | 27 | 0.8 | 2.0 |
| Example 2 | | | | | | | | |
| Comparative | 98 | 98 | 43 | 98 | 98 | 26 | 0.8 | 2.0 |
| Example 3 | | | | | | | | |
| Comparative | 98 | 98 | — | 98 | 98 | 25 | — | 2.0 |
| Example 4 | | | | | | | | |

### [Evaluation]

### (Developed Area Ratio of Contact Interface)

A cross section of an electrode laminate obtained in each of Examples 1 to 3 and Comparative Examples 1 to 4 was observed using a scanning electron microscope (SEM), and the developed area ratio of the contact interface of each layer was measured. The developed area ratio was measured at three places for each layer. An average value of the obtained developed area ratios is shown in Table 3 described below.

### (Battery Characteristics)

In the electrode laminate obtained in each of Examples 1 to 3 and Comparative Examples 1 to 4, the positive electrode terminal was connected to the positive electrode lead wire, and the negative electrode terminal was connected to the negative electrode lead wire. Next, the electrode laminate was housed in the exterior housing body and the exterior housing body was sealed such that the end portions of the positive electrode terminal and the negative electrode terminal protrude, so that the solid-state secondary battery was obtained. For the obtained solid-state secondary battery, a direct current resistance, a discharge capacity at 1/3C, whether charging and discharging at 1/3C are possible, and a lithium deposition position were measured by the following method. Each measurement was performed at 25° C. The results are shown in Table 3 described below.

### (Direct Current Resistance)

In a charged state of SOC50 at a temperature of 25° C., a direct current resistance (Ω·cm²) was calculated by the following equation from the voltage drop ΔV (V), the current value I (A), and the positive electrode area Ac (cm²) during discharging at the current density of 15.1 mA/cm². Direct current resistance (Ω·cm²)=voltage drop ΔV (V)/current value I (A)×positive electrode area Ac (cm²)

### (Discharge Capacity at 1/3C)

The charge and discharge test was performed at a temperature of 25° C., a charging upper limit voltage of 4.3V, a discharging lower limit of 2.65 V, a C rate of 1/3C, and a current density of 1.3 mA/cm². The discharge capacity after first charging was defined as an 1/3C discharge capacity.

### (Whether Charging and Discharging at 1/3C are Possible)

A case where with respect to a design capacity of 100%, the charge and discharge capacity during charging and discharging at a temperature of 25° C. and 1/3C was 95 to 105%, and a short circuit behavior did not occur during or after charging and discharging was evaluated as “A” (possible). A case where a short circuit behavior occurred during or after charging and discharging, the charge capacity was excessively large with respect to the design capacity, or a self-discharge amount is large after charging was evaluated as “B” (not possible).

### (Lithium Deposition Position)

The solid-state secondary battery was disassembled after 1 cycle or when charging and discharging at 1/3C became impossible, and it was confirmed whether the lithium was deposited at places other than between the intermediate layer and the negative electrode layer. A case where the lithium was not deposited on places other than between the intermediate layer and the negative electrode layer was evaluated as “A” (good), and a case where the lithium was deposited on places other than between the intermediate layer and the negative electrode layer was evaluated as “B” (not good).

TABLE 3

| | Developed area ratio of contact interface | | | | | | | |
|---|---|---|---|---|---|---|---|---|
| | Positive | | | | Battery characteristics | | | |
| | electrode | | | Solid | Direct | | | |
| | active | Solid | Intermediate | electrolyte | current | | Whether | |
| | material | electrolyte | layer- | layer- | resistance | Discharge | charging and | |
| | layer-solid | layer- | negative | negative | 15.1 mA/cm² | capacity | discharging | Lithium |
| | electrolyte | intermediate | electrode | electrode | 10 sec | at 1/3 C | at 1/3 C are | deposition |
| | layer | layer | layer | layer | (Ω · cm²) | (mAh/g) | possible | position |
| Example 1 | 2.45 | 1.34 | 0.39 | — | 15.3 | 166 | A | A |
| Example 2 | 2.45 | 1.39 | 0.40 | — | 15.2 | 167 | A | A |
| Example 3 | 2.46 | 1.46 | 0.45 | — | 14.8 | 167 | A | A |
| Comparative | 0.18 | 1.32 | 0.39 | — | 132.7 | 43 | B | B |
| Example 1 | | | | | | | | |
| Comparative | 0.19 | 0.18 | 0.39 | — | 165.7 | 35 | B | B |
| Example 2 | | | | | | | | |
| Comparative | 2.45 | 0.17 | 0.39 | — | 95.8 | 67 | B | B |
| Example 3 | | | | | | | | |
| Comparative | 2.45 | — | — | 0.17 | 134.3 | 7 | B | — |
| Example 4 | | | | | | | | |

The results in Table 3 indicate that the solid-state secondary battery using the electrode laminate obtained in each of Examples 1 to 3 has a higher developed area ratio of the contact interface between the layers, a lower direct current resistance, and a larger discharge capacity at 1/3C, as compared with the solid-state secondary battery using the electrode laminate obtained in each of Comparative Examples 1 to 3.

### EXPLANATION OF REFERENCE NUMERALS

1 Solid-state secondary battery
10 Electrode laminate
20 Positive electrode layer
21 Positive electrode current collector
22 Positive electrode active material layer
25 Positive electrode lead wire
26 Positive electrode terminal
30 Negative electrode layer
31 Negative electrode current collector
32 Metal layer
35 Negative electrode lead wire
36 Negative electrode terminal
40 Solid electrolyte layer
50 Intermediate layer
60 Exterior housing body

What is claimed is:

1. A solid-state secondary battery comprising:
an electrode laminate that includes:
a positive electrode layer including a positive electrode current collector and a positive electrode active material layer;
a negative electrode layer including a negative electrode current collector facing the positive electrode active material layer;
a solid electrolyte layer placed between the positive electrode layer and the negative electrode layer; and
an intermediate layer placed between the negative electrode layer and the solid electrolyte layer,
each of the positive electrode layer, the solid electrolyte layer, the intermediate layer, and the negative electrode layer being joined to an adjacent layer,
wherein a composite modulus of elasticity of the positive electrode active material layer before the positive electrode layer and the solid electrolyte layer are joined to each other is less than 30 GPa and a composite modulus of elasticity of the solid electrolyte layer before the joining is less than 15 GPa,
a composite modulus of elasticity of the solid electrolyte layer before the solid electrolyte layer and the intermediate layer are joined to each other is less than 18 GPa and a composite modulus of elasticity of the intermediate layer before the joining is less than 1 GPa, and
a composite modulus of elasticity of each layer of the positive electrode active material layer, the solid electrolyte layer, the intermediate layer, and the negative electrode layer in the electrode laminate satisfies a relationship of intermediate layer<negative electrode layer<solid electrolyte layer<positive electrode active material layer.

2. The solid-state secondary battery according to claim 1, wherein
a relative density of the positive electrode active material layer before the positive electrode layer and the solid electrolyte layer are joined to each other is less than 75% and a relative density of the solid electrolyte layer before the joining is less than 75%,
a relative density of the solid electrolyte layer before the solid electrolyte layer and the intermediate layer are joined to each other is less than 85% and a relative density of the intermediate layer before the joining is less than 40%, and
among the positive electrode active material layer, the solid electrolyte layer, the intermediate layer, and the negative electrode layer in the electrode laminate, the intermediate layer has a smallest relative density.

3. The solid-state secondary battery according to claim 1, wherein each of developed area ratios of contact interfaces between layers including the positive electrode active material layer, the solid electrolyte layer, the intermediate layer, and the negative electrode layer is 0.2 or more.

4. The solid-state secondary battery according to claim 1, wherein a composite modulus of elasticity of the intermediate layer in the electrode laminate is less than 1 GPa.

5. The solid-state secondary battery according to claim 1, wherein a relative density of the intermediate layer in the electrode laminate falls within a range of 30% or more and 60% or less.

6. The solid-state secondary battery according to claim 1, wherein the intermediate layer in the electrode laminate includes amorphous carbon particles.

7. A solid-state secondary battery comprising:
an electrode laminate that includes:
a positive electrode layer including a positive electrode current collector and a positive electrode active material layer;
a negative electrode layer including a negative electrode current collector facing the positive electrode active material layer;
a solid electrolyte layer placed between the positive electrode layer and the negative electrode layer; and
an intermediate layer placed between the negative electrode layer and the solid electrolyte layer,
each of the positive electrode layer, the solid electrolyte layer, the intermediate layer, and the negative electrode layer being joined to an adjacent layer,
wherein each of developed area ratios of contact interfaces between layers including the positive electrode active material layer, the solid electrolyte layer, the intermediate layer, and the negative electrode layer is 0.2 or more.

8. The solid-state secondary battery according to claim 7, wherein a developed area ratio of a contact interface between the positive electrode active material layer and the solid electrolyte layer is highest, a developed area ratio of a contact interface between the solid electrolyte layer and the intermediate layer is next high, and a developed area ratio of a contact interface between the intermediate layer and the negative electrode layer is lowest.

9. The solid-state secondary battery according to claim 7, wherein a developed area ratio of a contact interface between the positive electrode active material layer and the solid electrolyte layer falls within a range of 1.5 times or more and 3.0 times or less with respect to a developed area ratio of a contact interface between the solid electrolyte layer and the intermediate layer, and the developed area ratio of the contact interface between the solid electrolyte layer and the intermediate layer falls within a range of 2.0 times or more and 5.0 times or less with respect to a developed area ratio of a contact interface between the intermediate layer and the negative electrode layer.

10. A method of manufacturing a solid-state secondary battery comprising an electrode laminate that comprises:
a positive electrode layer including a positive electrode current collector and a positive electrode active material layer; a negative electrode layer including a negative electrode current collector facing the positive electrode active material layer;
a solid electrolyte layer placed between the positive electrode layer and the negative electrode layer; and
an intermediate layer placed between the negative electrode layer and the solid electrolyte layer,
each of the positive electrode layer, the solid electrolyte layer, the intermediate layer, and the negative electrode layer being joined to an adjacent layer,
the method comprising:
a first joining step of joining the positive electrode active material layer and the solid electrolyte layer to obtain a positive electrode layer-solid electrolyte assembly;
a second joining step of joining the solid electrolyte layer in the positive electrode layer-solid electrolyte layer assembly and the intermediate layer to obtain a positive electrode layer-solid electrolyte layer-intermediate layer assembly; and
a third joining step of joining the intermediate layer in the positive electrode layer-solid electrolyte layer-intermediate layer assembly and the negative electrode layer to the electrode laminate,
wherein in the first joining step, a composite modulus of elasticity of the positive electrode active material layer before the joining is less than 30 GPa and a composite modulus of elasticity of the solid electrolyte layer before the joining is less than 10 GPa, and
in the second joining step, a composite modulus of elasticity of the solid electrolyte layer before the joining is less than 18 GPa and a composite modulus of elasticity of the intermediate layer before the joining is less than 1 GPa.
